(19) United States
(12) Patent Application Publication
(10) Pub. No.: US 2026/0084329 A1
(43) Pub. Date: Mar. 26, 2026

(54) Floor Cutting Tool and Uses and Methods Thereof

(71) Applicants: Pamela Desangles Benimeli, Ottawa, ON (CA); Ivan Yazmani Aleman Cabrera, Ottawa, ON (CA)

(72) Inventors: Pamela Desangles Benimeli, Ottawa, ON (CA); Ivan Yazmani Aleman Cabrera, Ottawa, ON (CA)

(21) Appl. No.: 19/109,914

(22) PCT Filed: Sep. 7, 2023
(86) PCT No.: PCT/CA2023/051181

§ 371 Date: Mar. 7, 2025

Related U.S. Application Data
(60) Provisional application No. 63/404,594, filed on Sep. 8, 2022.

(51) Int. Cl. B26B 27/00; E04G 23/08

(52) U.S. Cl. CPC B26B 27/00; E04G 23/082

(57) ABSTRACT

A floor cutting tool comprising one or more blades on a beveled base that is forcibly inserted under and through material adhered to a surface, such as flooring or subflooring, that requires removal. The force is generated by striking a plate connected to the blade and beveled base with a hammer or sledgehammer, or by using an electric or pneumatic tool connected to this floor cutting tool. The cutting allows for the more efficient use of floor removal tools and quicker/easier removal of flooring and subflooring.

### FIELD OF INVENTION

The present invention relates to a floor cutting tool, and, in particular, a floor cutting tool that can manually or mechanically be used to easily and efficiently cut through flooring/subflooring and facilitate floor removal with this or other tools.

### BACKGROUND OF THE INVENTION

The present invention relates to a floor cutting tool and the uses and methods thereof. Currently there is a need in the art for a tool capable of cutting flooring, subflooring or a combination thereof to facilitate the subsequent removal of said materials using other tools or devices. At present, floor cutting or demolition is conducted with the use of electric tile breaker tools, power strippers, or jackhammers. These tools are often floor-type specific, ineffective, and risk damage to the material underneath the flooring or subflooring to be removed. Moreover, manual floor demolition and removal can be an inefficient and slow process, requiring the use of various crow and pry bars to remove small sections of flooring at a time. This often requires a significant amount of physical labor and bending, which can lead to workplace-related injuries. The cutting of flooring and/or subflooring into sections can significantly increase the efficiency of the floor removal task and make the use of crow or pry bars much easier and effective.

### SUMMARY OF THE INVENTION

The present invention relates to a tool for the cutting of a material, such as flooring or subflooring, adhered to a surface.

According to the present invention there is provided a floor cutting tool comprising a base member, which further comprises a thin plate member. The thin plate member comprises a bevel or wedge along its length and at a proximal side, with the opposite distal side of the thin plate member mating with or integrally attached to a second plate member. The second plate member extends transversely upward therefrom.

The base member of the floor cutting tool further comprises at least one blade member, wherein the at least one blade member comprises a lower portion with an optional upper portion. The lower portion comprises a blade that spans the length of the base member and is angled upward from the proximal side to the distal side, mating or integral with the second plate member at the distal side. The optional upper portion of the at least one blade member comprises a blade connected to or continuous from the lower portion of the at least one blade member. This upper portion extends from the distal side toward the proximal side at an angle such that the widest part of the upper portion of the at least one blade member is at the distal side. The upper portion of the at least one blade member ends approximately halfway along the length of the base member and rises to the height of the second plate member.

The base member of the floor cutting tool further comprises a bracing member, which forms an integral attachment with both the thin plate member and the second plate member. This bracing member is integral with or adjacent to the lower portion of the at least one blade member, and forms a solid or hollow member or tube. This hollow member or tube comprises an aperture on the reverse side of the second plate member, for optionally receiving a tool engaging member. The tool engaging member engages a surface inside, around or both inside and around the aperture on the reverse of the second plate member.

In a further embodiment, there is provided the above floor cutting tool wherein the base member further comprises a handle attachment member attached or integral with the second plate member and extending therefrom. The handle attachment member is adapted to receive a handle.

In a further embodiment, there is provided the above floor cutting tool wherein the aperture on the reverse side of the second plate member receives a tool engaging member, an electric tool, or a pneumatic tool.

In a further embodiment, there is provided the above floor cutting tool wherein the aperture on the reverse side of the second plate member is surrounded by a mating assembly for receiving a tool engaging member, an electric tool, or a pneumatic tool.

In a further embodiment, there is provided the above floor cutting tool, wherein the tool is made of high carbon steel.

In a further embodiment, there is provided the use of the above floor cutting tool to cut through a material adhered to a surface.

In a further embodiment, there is provided the above use of the floor cutting tool, wherein the material adhered to a surface is flooring, subflooring, or a combination thereof.

In a further embodiment, there is provided a method of cutting a material adhered to a surface, comprising positioning the above floor cutting tool adjacent to the material to be cut and striking the second plate member with a man-powered tool to insert the floor cutting tool under the material and initiate cutting.

In a further embodiment, there is provided the above method wherein the man-powered tool is a hammer or sledgehammer.

In a further embodiment, there is provided a method of cutting a material adhered to a surface, comprising positioning the above floor cutting tool adjacent to the material and activating an electric or pneumatic tool to insert the floor cutting tool under the material and initiate cutting.

In a further embodiment, there is provided the above method wherein the material adhered to a surface is flooring, subflooring, or a combination thereof.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a side view of the floor cutting tool (10), which comprises a base member (20), which further comprises a thin plate member (30), a bevel or wedge (40), a proximal side (50), a distal side (60), a second plate member (70), a bracing member (110), a tool engaging member (160) and a blade member (80). The blade member (80) comprises a lower portion (100) and an upper portion (90).

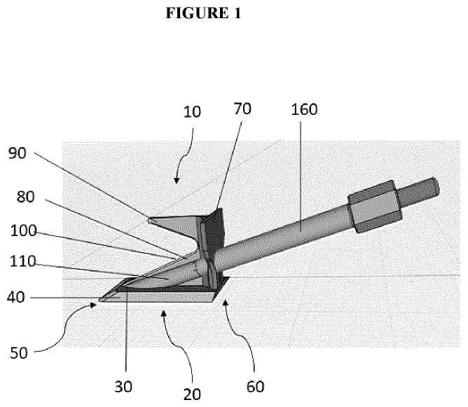

FIG. 2 shows the back view of the floor cutting tool (10), which comprises a base member (20), which further comprises a thin plate member (30), a bevel or wedge (40), a distal side (60), a second plate member (70), an aperture (130), a tool engaging member (160), and a blade member (80). The blade member further comprises a lower portion (100) and an upper portion (90).

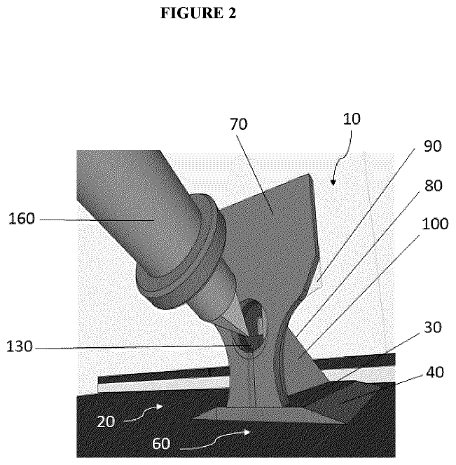

FIG. 3 shows a side view of the floor cutting tool (10), which comprises a base member (20), which further comprises a bevel or wedge (40), a proximal side (50), a distal side (60), a second plate member (70), a bracing member (110), and a blade member (80). The blade member further comprises a lower portion (100) and an upper portion (90). Attached or integral with the second plate member is a handle attachment member (140), which is attached to a handle (150).

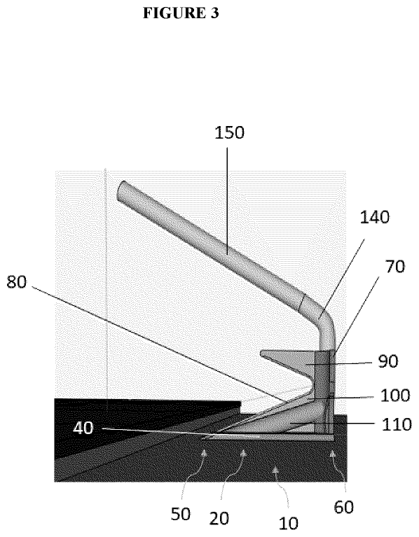

FIG. 4 shows the floor cutting tool (10), which comprises a base member (20), which further comprises a bevel or wedge (40), a proximal side (50), a distal side (60), and two parallel blade members (80). The blade members (80) further comprise a lower portion (100) and an upper portion (90).

FIG. 5 shows the side view of the floor cutting tool (10), which comprises a base member (20), which further comprises a bevel or wedge (40), a proximal side (50), a distal side (60), and two parallel blade members (80). The blade members (80) further comprise a lower portion (100) with teeth (200) and an upper portion (90).

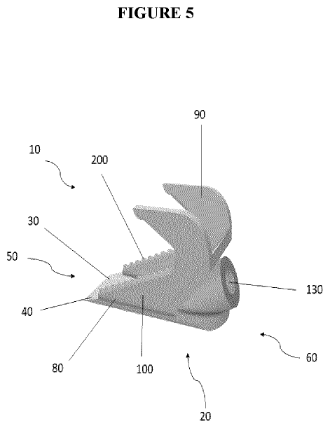

FIG. 6 shows the front view of the floor cutting tool (10), which comprises a base member (20), which further comprises a bevel or wedge (40), a proximal side (50), a distal side (60), and two parallel blade members (80). The blade members (80) further comprise a lower portion (100) with teeth (200) and an upper portion (90).

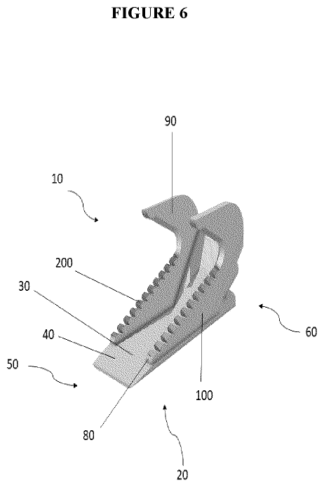

### DETAILED DESCRIPTION

In an embodiment of the present invention, there is provided a floor cutting tool (10) comprising, a base member (20) comprising a thin plate member (30), the thin plate member comprising a bevel or wedge (40) along its length and at a proximal side (50), the opposite distal side (60) of the thin plate member mating with or integrally attached to a second plate member (70), the second plate member extending transversely upward there-from,

at least one blade member (80), wherein the at least one blade member comprises a lower portion (100) and optionally an upper portion (90), the lower portion comprising a blade that spans the length of the base member and is angled upward from the proximal side to the distal side, mating or integral with the second plate member at the distal side, the optional upper portion comprising a blade connected to or continuous from the lower portion of the at least one blade member, that extends from the distal side toward the proximal side at an angle such that the widest part of the upper portion of the at least one blade member is at the distal side, wherein the upper portion of the at least one blade member ends approximately halfway along the length of the base member and rises to the height of the second plate member,

a bracing member (110), the bracing member forming an integral attachment with both the thin plate member and the second plate member, wherein the bracing member is integral with or adjacent to the lower portion of the at least one blade member, the bracing member forming a solid or hollow member or tube, the hollow member or tube comprising an aperture (130) on the reverse side of the second plate member, the aperture for optionally receiving a tool engaging member, the tool engaging member engaging a surface inside, around or both inside and around the aperture on the reverse of the second plate member.

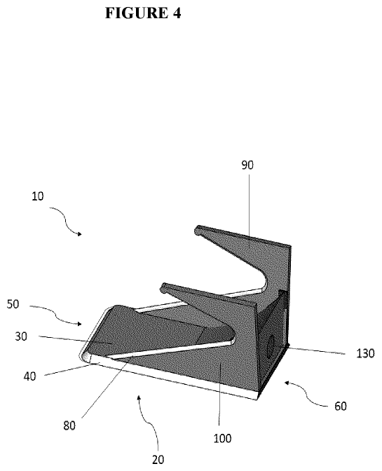

The present embodiment describes a floor cutting tool, however it is contemplated that this tool may be used, without being limiting, to cut materials from walls or ceilings. This may include, but is not limited to, wall and ceiling tiles. In another embodiment, the thin plate member may not have a bevel or wedge, or the bevel or wedge may be present solely on the proximal side of the floor cutting tool. Moreover, the thin plate member of the floor cutting can be, without being limiting, square or rectangular in shape. It is also envisioned that the thin plate member is not limited to a particular thickness and can be any thickness needed for insertion under a material to be cut. In another contemplated embodiment, the second plate member may be perpendicular to the thin plate member or may be angled so as to allow a striking force to be more effectively applied to the second plate member, as compared to when the second plate member and the thin plate member are arranged at different angles. In an embodiment of the present invention, the second plate member extends about vertically to a degree such that a device or tool used to apply force to the floor cutting tool can contact the surface without a significant degree of difficulty by someone skilled in the art. It is also contemplated that the second plate member may be rectangular or any other shape. It is further contemplated that the thin plate member and the second plate member may be of sufficient thickness such that the bracing member is not necessary for withstanding and transferring the force applied to the second plate member to the thin plate member. Another embodiment of the floor cutting tool includes more than one bracing member spaced variably along the joint between the thin plate member and second plate member. In a further embodiment, the at least one blade member is a plurality of parallel blades spaced variably (e.g. FIG. 4), without being limiting, to achieve the desired result. It is further contemplated that the at least one blade member comprises only the lower portion. It is further envisioned that the lower portion of the at least one blade member is not angled up from the proximal side to the distal side but may be a straight blade extending from the proximal side to the distal side of the floor cutting tool. It is also contemplated that the lower portion of the at least one blade member does not span the length of the thin plate member, but spans some measure between the proximal and distal sides. The lower portion of the at least one blade member may also be serrated, such that the teeth point at an angle relative to the thin plate member to facilitate the desired function of the floor cutting tool. These teeth may span the entire length of the lower portion of the at least one blade member or may span only a portion of its length. It is also envisioned that if the floor cutting tool comprises a plurality blade members, some or all of these blade members may be serrated. Also provided is an embodiment wherein the upper portion of the at least one blade member may not need to be a blade but may be some other structure to facilitate the function of the floor cutting tool. The upper portion of the at least one blade member may also span some measure, without being limiting, of the distance between the proximal and distal sides of the base member. Moreover, the upper portion of the at least one blade member may not be angled but may be straight.

In another embodiment of the above floor cutting tool, there is provided the base member further comprising a handle attachment member (140) attached or integral with the second plate member (70) and extending therefrom, the handle attachment member adapted to receive a handle (150). It is further contemplated that the handle attachment member may be attached or integral with the thin plate member or both the thin plate member and the second plate member. It is further envisioned that the handle attached to said handle attachment member may be of variable length and may be, without being limiting, curved or linear. The handle may be attached to the handle attachment member in a permanent way or may be reversibly attached by, without being limiting, spring-loaded members, one or more quick-release pins, or screw threads or any other method as would be known to someone of skill in the art.

In a further embodiment of the above floor cutting tool, there is provided the floor cutting tool wherein the aperture (130) on the reverse side of the second plate member receives a tool engaging member, an electric tool, or a pneumatic tool (160). It is contemplated that the tool engaging member may encompass any structure that allows the attachment of an extrinsic device or tool that would facilitate the desired function of the floor cutting tool. In another embodiment, the pneumatic or electric tool may be, but is not limited to, a jackhammer, an air hammer, a chipping hammer, or other air-powered or electric device capable of facilitating the function of the floor cutting tool.

In a further embodiment of the above floor cutting tool, there is provided a floor cutting tool wherein the aperture on the reverse side of the second plate member forms or is surrounded by a mating assembly for receiving a tool engaging member, an electric tool, or a pneumatic tool (160). The mating assembly is contemplated to be a structure that is capable of attaching an extrinsic device or tool to facilitate the function of the floor cutting tool.

In a further embodiment of the above floor cutting tool, there is provided a floor cutting tool wherein the tool is made of steel, for example, but not limited to high carbon steel. However, the floor cutting tool or any part thereof may be made from a different durable substance such as, but not limited to, other steel alloys as would be understood by a person of skill in the art. Further, another embodiment of the present invention may comprise a hard rubber, impact-resistant backing for the second plate member to minimize sound irritation when the user strikes the second plate member with another tool or device. It is envisioned that this backing may not be limited to hard rubber, but may include any impact-resistant material.

In a further embodiment, there is provided a use for the above floor cutting tool wherein the floor cutting tool is used to cut through a material adhered to a surface. It is envisioned that this material may be adhered by for example, without being limiting, glue, nails, staples, or screws.

In a further embodiment, there is provided the above use of the floor cutting tool wherein the material adhered to a surface is flooring, subflooring, or a combination thereof. It is contemplated that the floor cutting tool could cut various types of flooring such as, but not limited to, tile, hardwood, laminate, vinyl flooring or any combination thereof. Other types of material adhered to the floor are also contemplated. It is also envisioned that the types of subflooring that this tool may cut through include, but is not limited to, felt, rubber, foam, wood, or cork subfloors, vapour barrier underlay, fiber cement panels, separation membranes, and acoustic membranes. Other types of subfloor material are also contemplated.

In a further embodiment, there is provided a method of cutting a material adhered to a surface, comprising:
a. positioning the above floor cutting tool adjacent to the material, and
b. striking the second plate member with a man-powered tool to insert the floor cutting tool under the material and initiate the cutting of said material.

It is contemplated that the floor cutting tool may be inserted under some portion of the material to be cut before the striking action commences. It is further envisioned that the second plate member may need to be struck one or more times to achieve the desired result.

In a further embodiment, there is provided the above method wherein the man-powered tool used to cut through a material adhered to a surface is a hammer or sledgehammer. It is further envisioned that the second plate member may be struck by another device such as a crowbar or mallet, without being limiting.

In a further embodiment, there is provided a method of cutting a material adhered to a surface, comprising:
a. positioning the above floor cutting tool adjacent to the material,
b. activating an electric or pneumatic tool to insert the floor cutting tool under the material and initiate the cutting of said material.

It is also contemplated that the initiation of the cutting of the material adhered to a surface may first be provided by a man-powered tool, with the majority of the floor cutting then being conducted through the activation of an electric or pneumatic tool. It is further contemplated that the electric or pneumatic tool is, without being limiting, a jackhammer, air hammer, chipping hammer, or other air-powered or electric device capable of facilitating the function of the floor cutting tool.

In a further embodiment, there is provided the above method wherein the material adhered to a surface is flooring, subflooring, or a combination thereof. It is contemplated that the floor cutting tool could cut various types of flooring such as, but not limited to, tile, hardwood, laminate, vinyl flooring or any combination thereof. Other types of material adhered to the floor are also contemplated. It is also envisioned that the types of subflooring that this tool may cut through include, but is not limited to, felt, rubber, foam, wood, or cork subfloors, vapour barrier underlay, fiber cement panels, separation membranes, and acoustic membranes. Other types of subfloor material are also contemplated.

The present invention has been described with regard to one or more embodiments. However, it will be apparent to persons skilled in the art that a number of variations and modifications can be made without departing from the scope of the invention as defined in the claims.

1. A floor cutting tool (10) comprising,
a base member (20) comprising a thin plate member (30), the thin plate member comprising a bevel or wedge (40) along its length and at a proximal side (50), the opposite distal side (60) of the thin plate member mating with or integrally attached to a second plate member (70), the second plate member extending transversely upward therefrom,
at least one blade member (80), wherein the at least one blade member comprises a lower portion (100) and optionally an upper portion (90), the lower portion comprising a blade that spans the length of the base member and is angled upward from the proximal side to the distal side, mating or integral with the second plate member at the distal side, the optional upper portion comprising a blade connected to or continuous from the lower portion of the at least one blade member, that extends from the distal side toward the proximal side at an angle such that the widest part of the upper portion of the at least one blade member is at the distal side, wherein the upper portion of the at least one blade member ends approximately halfway along the length of the base member and rises to the height of the second plate member,
a bracing member (110), the bracing member forming an integral attachment with both the thin plate member and the second plate member, wherein the bracing member is integral with or adjacent to the lower portion of the at least one blade member, the bracing member forming a solid or hollow member or tube, the hollow member or tube comprising an aperture (130) on the reverse side of the second plate member, the aperture for optionally receiving a tool engaging member, the tool engaging member engaging a surface inside, around or both inside and around the aperture on the reverse of the second plate member.

2. The floor cutting tool of claim 1, wherein the base member further comprises a handle attachment member (140) attached or integral with the second plate member (70) and extending therefrom, the handle attachment member adapted to receive a handle (150).

3. The floor cutting tool of claim 1 wherein the aperture (130) on the reverse side of the second plate member receives a tool engaging member, an electric tool, or a pneumatic tool (160).

4. The floor cutting tool of claim 1 wherein the aperture on the reverse side of the second plate member is surrounded by a mating assembly for receiving a tool engaging member, an electric tool, or a pneumatic tool (160).

5. The floor cutting tool of claim 1, wherein the tool is made of high carbon steel.

6. The use of the floor cutting tool of claim 1 to cut through a material adhered to a surface.

7. The use of claim 6, wherein the material is flooring, subflooring, or a combination thereof.

8. A method of cutting a material adhered to a surface, comprising:
a. positioning the floor cutting tool of claim 1 adjacent to the material, and
b. striking the second plate member with a man-powered tool to insert the floor cutting tool under the material and initiate the cutting of said material.

9. The method of claim 8, wherein the man-powered tool is a hammer or sledgehammer.

10. A method of cutting a material adhered to a surface, comprising:
a. positioning the floor cutting tool of claim 3 adjacent to the material,
b. activating the electric or pneumatic tool to insert the floor cutting tool under the material and initiate the cutting of said material.

11. The method of claim 8, wherein the material is flooring, subflooring, or a combination thereof.
